(19) United States
(12) Patent Application Publication
(10) Pub. No.: US 2003/0086146 A1
(43) Pub. Date: May 8, 2003

(54) Optical attenuation device for use as an optical add/drop with spectrally selective attenuation and a method of manufacture therefor

(76) Inventor: Mark M. Meyers, Allentown, PA (US)

Correspondence Address: HITT GAINES & BOISBRUN P.C., P.O. BOX 832570, RICHARDSON, TX, 75083, US

(21) Appl. No.: 09/993,279

(22) Filed: Nov. 5, 2001

(51) Int. Cl. G02B 26/00; G02B 27/10

(52) U.S. Cl. 359/291

(57) ABSTRACT

The present invention provides an optical device, a method of manufacture therefor, and an optical system including the same. In an advantageous embodiment, the optical device includes an array of movable mirrors, and a transparent substrate located adjacent the array of movable mirrors and having an array of micro lenses located thereon. In an alternative advantageous embodiment, the transparent substrate is aligned with the array of movable mirrors, such that each micro lens is aligned with a corresponding mirror of the array of movable mirrors.

### TECHNICAL FIELD OF THE INVENTION

The present invention is directed, in general, to an optical device and, more specifically, to an optical device, a method of manufacture therefor, and an optical communications system including the same.

### BACKGROUND OF THE INVENTION

Optical amplification devices are gaining widespread use in today's increasingly important optoelectronics industry. One optical amplification device that is particularly useful is an erbium doped fiber amplifier (EDFA). EDFA's are generally used as power amplifiers, as pre-amplifiers, or as in-line amplifiers in long (e.g., >100 km) transmission lines. See, for instance, J. M. Delavaux et al., J. Lightwave Technology, Vol. 13(5), p. 703. EDFA's have been found to have low cost, exhibit low-noise, provide relatively large bandwidth that is not polarization dependent, display substantially reduced crosstalk, and present low insertion losses at relevant operating wavelengths. As a result of their favorable characteristics, EDFA's are replacing current optoelectronic regenerators in many optical lightwave communications systems, and particularly, wavelength-division-multiplexed (WDM) optical communications systems.

While EDFA's are particularly useful, they experience certain drawbacks. One known drawback of EDFA's is that the gain of an EDFA is not flat over a wide range WDM bandwidths (e.g., non-uniform over a wide range WDM bandwidths). As such, the number of channels in fiber communications systems employing EDFA's is limited, which is a characteristic that is generally undesirable in today's competitive optoelectronics industry. Additionally, non-uniform gain causes changes in signal to noise as a function of frequency channel. This renders some channels unusable, especially after cascading a number of stages.

Attempts to correct the non-uniform gain in the EDFA's have involved various approaches. One approach includes adding gain equalization filters (GEF's) in the EDFA's. Unfortunately, however, the correct design of a particular GEF is often difficult to produce analytically or numerically. In particular, numerical simulation methods are oftentimes inaccurate, resulting in part from errors in EDF parameters, component loss estimation, and spectral hole burning. Additionally, in some cases the gain spectrum of the EDFA's are time and temperature dependent.

Another approach includes using an etalon formed with a deformable membrane to separately attenuate individual channels of the optical signal. Such systems disperse the light from each of the individual channels into discrete spots using a diffraction grating and a single focusing lens. By changing a thickness of the etalon cavity defined by the deformable membrane, the relative reflectance of the individual channels can be adjusted to allow for correcting the wavelength dependent gain of the EDFA's. This configuration, however, suffers from lack of dynamic range in attenuation and control, and difficulty in fabricating stable etalon devices. Higher dynamic range can be achieved with higher reflectance coatings, but the control of the attenuation is significantly more difficult, due to the reduced range of voltage needed to achieve full attenuation.

Another approach attempted to correct the non-uniform gain in the EDFA's, includes using diffraction gratings and reflective surfaces to cause various channels of an optical signal to re-enter the optical fiber at an angle. If such circumstances, there is an effect where coupling efficiency back into the fiber is a function of angle. While altering the angle of entry can achieve larger drops in coupling efficiency (e.g., attenuation), it tends to be a fairly slow process and is limited by the angle of deflection.

Accordingly, what is needed in the art is optical device and a method of manufacture therefor, that does not experience many of the problems experienced by the prior art devices.

### SUMMARY OF THE INVENTION

To address the above-discussed deficiencies of the prior art, the present invention provides an optical device, a method of manufacture therefor, and an optical system including the same. In an advantageous embodiment, the optical device includes an array of movable mirrors, and a transparent substrate located adjacent the array of movable mirrors and having an array of micro lenses located thereon. In an alternative advantageous embodiment, the transparent substrate is aligned with the array of movable mirrors, such that each micro lens is aligned with a corresponding mirror of the array of movable mirrors. In an exemplary embodiment, the optical device allows displacement of an output focal spot from an input focal spot, therefore causing attenuation.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description, when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrates a plan view of an optical device, which has been constructed in accordance with the principles of the present invention;

FIG. 2 illustrates a plan view of an optical system, which is also constructed in accordance with the principles of the present invention;

FIG. 3 illustrates a plan view of an optical communications system, which may form one environment in which an optical system in accordance with the principles of the present invention, may be used; and

FIG. 4 illustrates a plan view of an alternative optical communications system, having a second transmitter and a second receiver.

### DETAILED DESCRIPTION

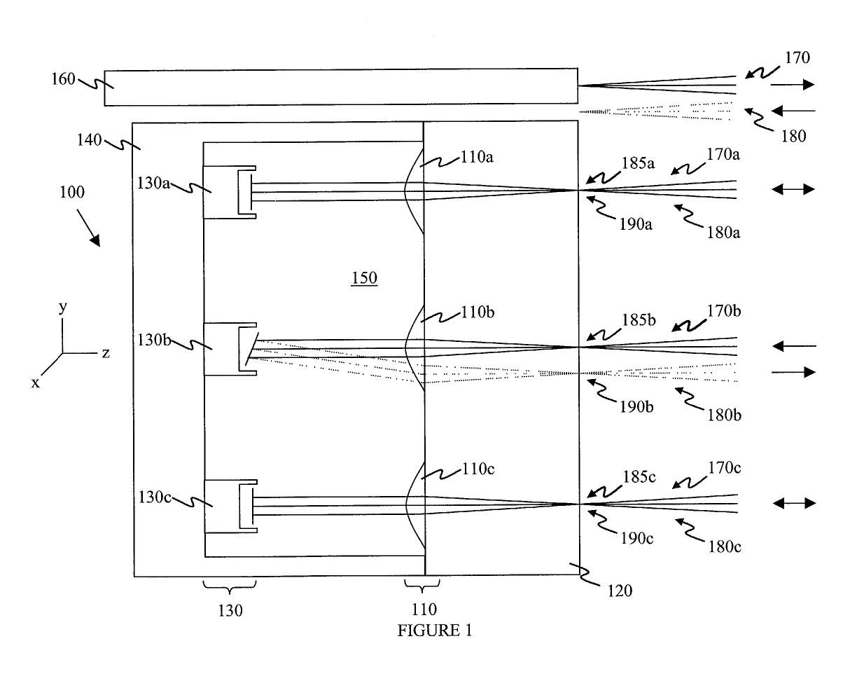

Referring initially to FIG. 1, illustrated is a plan view of an optical device 100, which has been constructed in accordance with the principles of the present invention. In the illustrative embodiment shown in FIG. 1, the optical device 100 includes an array of micro lenses 110 formed on a transparent substrate 120. As shown, the array of micro lenses 110 includes three individual micro lenses 110a, 110b, 110c. It should be noted, however, that the number of micro lenses that may be included within the array of micro lenses 110 may vary. For example, the number of micro lenses included in the array 110 may be as many as 40 or more.

As previously recited, the array of micro lenses 110 may be formed on a transparent substrate 120. Materials such as fused silica, glass, silicon, or many other transparent materials, may comprise the transparent substrate 120. While it has been shown that the array of micro lenses 110 may be formed directly on the transparent substrate 120, it should be noted that the array of micro lenses 110 may, in an alternative embodiment, be formed as an integral part of the transparent substrate 120. In such embodiments, the array of micro lenses 110 may comprise a similar material as the transparent substrate 120. It should also be noted, that in an alternative embodiment the array of micro lenses 110 may be formed on an opposing side of the transparent substrate 120 as shown in the embodiment illustrated in FIG. 1. Additionally, the micro lenses 110 may, in an exemplary embodiment, be sustained by any other support structure capable of precisely supporting each individual micro lens 110a, 110b, 110c.

The array of micro lenses 110 may have a variety of shapes, widths and thicknesses. For example in one particularly advantageous embodiment, the array of micro lenses 110 may be spherical, aspherical, or cylindrical (e.g., anamorphic), as well as refractive or diffractive. In an exemplary embodiment the shape, width and thicknesses of the array of micro lenses 110 is configured to provide micro lenses 110a, 110b, 110c having focal lengths ranging from about 50 μm to about 500 μm. While a preferred focal length is stated, one skilled in the art understands that any focal length is within the scope of the present invention.

Located adjacent the array of micro lenses 110 is an array of movable mirrors 130. A distance between the array of micro lenses 110 and the array of movable mirrors 130 may vary, however, in an exemplary embodiment the distance ranges from about 100 μm to about 1000 μm. In the illustrative embodiment, the array of movable mirrors 130 includes three individual micro-electro mechanical system (MEMS) mirrors 130a, 130b, 130c. However, similar to above, the present invention should not be limited to just three MEMS mirrors 130a, 130b, 130c. In an exemplary embodiment, a number of individual MEMS mirrors 130a, 130b, 130c equals the number of individual micro lenses 110a, 110b, 110c. Therefore, the number of individual MEMS mirrors may also be up to about 40 or more. The individual MEMS mirrors 130a, 130b, 130c should, however, be alligned with the corresponding individual micro lenses 110a, 110b, 110c, as illustrated.

Also located in the particular embodiment shown in FIG. 1, is a housing 140 having an opening 150 therein. As illustrated, the housing 140 may be configured to receive the array of movable mirrors 130. The housing 140 may comprise a number of materials while staying within the scope of the present invention. In the illustrative embodiment, the transparent substrate 120 is positioned over the opening 150, such that the transparent substrate 120 acts as a cap for the housing 140. In one particularly advantageous embodiment, the transparent substrate 120 provides a hermetic seal for the housing 140, and thus, a hermetic seal for the array of movable mirrors 130. While the housing 140 is not required for the present invention to operate, one skilled in the art understands the benefits that may be received by using the housing 140 and the associated heremetic seal.

The optical device 100 illustrated in FIG. 1 is particularly useful in attenuating radiation traveling through a waveguide, such as an optical fiber 160. In the particular embodiment shown in FIG. 1, an output radiation spectrum 170 exits a center of the optical fiber 160. It should be understood that the terms “input” and “output” as used herein, are with respect to the optical fiber 160. After going through a number of lenses, a collimator, and in this particular instance a diffraction grating (not shown), the collimated output radiation spectrum 170 encounters the optical device 100. In the particular embodiment shown in FIG. 1, the output radiation spectrum 170 has been separated into three output radiation wavelengths 170a, 170b, 170c, by the diffraction grating (not shown). While the present invention is being discussed with respect to an output radiation spectrum 170 that has been separated into its individual output radiation wavelengths 170a, 170b, 170c, it should be understood that the optical device 100 may be applied to an output radiation spectrum 170 that has not been separated into its individual wavelengths.

As the three output radiation wavelengths 170a, 170b, 170c encounter the individual micro lenses 110a, 110b, 110c, and the associated individual movable mirrors 130a, 130b, 130c, input radiation wavelengths 180a, 180b, 180c are reflected back to the optical fiber 160, as an input radiation spectrum 180. As illustrated with respect to the output radiation wavelength 170b, and resulting input radiation wavelength 180b, tilting the movable mirror 130b may cause a lateral displacement between an output focal point 185b and input focal point 190b. In contrast, as illustrated with respect to the output radiation wavelength 170a, 170c, and the resulting input radiation wavelengths 180a, 180c, failing to tilt the movable mirrors 130a, 130c may result in substantially no lateral displacement between the output focal point 185a, 185c and the input focal point 190a, 190c. In such an instance, the only attenuation associated with the input radiation wavelengths 180a, 180c is a loss associated with the various mirrors and lenses.

In an exemplary embodiment, the lateral displacement between the output focal point 185b and the input focal point 190b of the various wavelengths, translates into a lateral displacement between the various wavelengths of output radiation spectrum 170 and the input radiation spectrum 180. In an advantageous embodiment, a translation between the two lateral displacements is a ratio of about 1:1. Thus, a displacement of the focal point results in a substantially similar displacement in the coupling of the input radiation spectrum 180. In the particular embodiment illustrated in FIG. 1, the attenuation is imparted only on the input radiation wavelength 180b. As such, the inventive optical device 100 is capable of obtaining wavelength dependent attenuation.

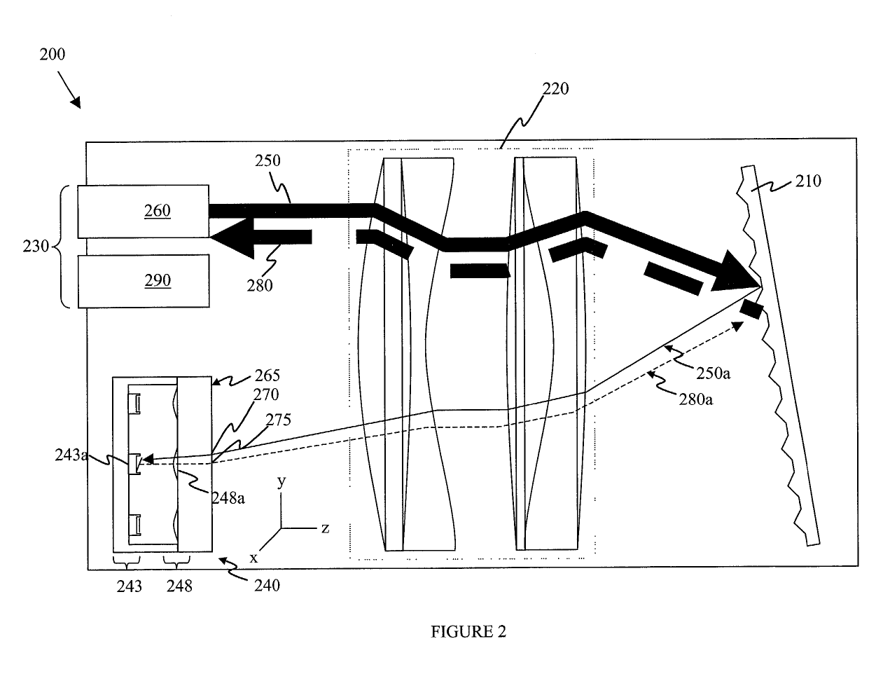

Turning now to FIG. 2, illustrated is a plan view of an optical system 200, which is also constructed in accordance with the principles of the present invention. In the illustrative embodiment shown in FIG. 2, the optical system 200 includes a conventional diffraction grating 210. The conventional diffraction grating 210, in an exemplary embodiment, is a reflective diffraction grating. The optical system 200 further includes a conventional optical collimator 220 located between the diffraction grating 210 and a radiation port 230.

In the current example, the diffraction grating 210 is designed to separate an output radiation spectrum 250 that has been collimated by the optical collimator 220, into its various wavelengths. One skilled in the art understands the various diffraction gratings 210 that could be used to separate the output radiation spectrum 250 into its various wavelengths. In one particular embodiment, a reflective diffraction grating 210 is used. One skilled in the art further understands the various collimators that may comprise the optical collimator 220. In an exemplary embodiment, the optical collimator 220 is an achromatized collimator, however, others are within the scope of the present invention.

The optical system 200 further includes an optical device 240, as described above with respect to FIG. 1. The optical device 240 may include an array of movable mirrors 243, and an array of micro lenses 248 located between the array of movable mirrors 243 and the optical collimator 220. As illustrated, each of the micro lenses of the array of micro lenses 248 is aligned with a corresponding movable mirror of the array of movable mirrors 243. While only certain elements of the optical system 200 have currently been shown and discussed, other elements may be included within the optical system 200 without departing from the scope of the present invention. Additionally, the elements may be oriented in various positions with respect to one another. For example, in an exemplary embodiment, the optical collimator is oriented at 90° to the array of movable mirrors.

A method for using the optical system 200 will now be discussed in accordance with the principles of the present invention. While a single line is used to represent the various radiation paths in FIG. 2, one skilled in the art understands that radiation generally travels in a diverging cone rather than a line, and that the line is used for simplicity of discussion only. In a true representation, the output radiation spectrum 250 exiting an optical fiber 260 would diverge in a cone whose angular extent is proportional to the optical fiber 260 diameter.

In the current example, the output radiation spectrum 250 exits the optical fiber 260 and encounters the optical collimator 220. As illustrated, the optical fiber 260 may be an off axis optical fiber, however, others may also be used. The optical collimator 220, which in this case is an achromatized collimator, collimates the output radiation spectrum 250. After the output radiation spectrum 250 has been collimated, the output radiation spectrum 250 encounters the diffraction grating 210. The diffraction grating 210 may then angularly disperse the output radiation spectrum 250 according to its wavelength. In an exemplary embodiment, the diffraction grating 210 separates the output radiation spectrum 250 into up to about 40 individual output radiation wavelengths. For simplicity in understanding the present invention, however, only one output radiation wavelength 250a is shown exiting the diffraction grating 210. One skilled in the art understands that while only one output radiation wavelength 250a has been shown exiting the diffraction grating 210, many output radiation wavelengths corresponding to the various wavelengths of an optical spectrum, may also exit the diffraction grating 210.

The output radiation wavelength 250a may be redirected by the diffraction grating 210 back through the optical collimator 220, wherein it is imaged onto a focal plane 265. If all of the various output radiation wavelengths were shown, each would be imaged onto the focal plane 265 at separated distances along the focal plane 265. In an exemplary embodiment, this focusing is caused by an interaction between the various separated output radiation wavelengths and the optical collimator 220.

In the current example, the output radiation wavelength 250a has an output focal point 270 on the focal plane 265. The output radiation wavelength 250a then encounters an individual micro lens 248a of the array of micro lenses 248, wherein the output radiation wavelength 250a is collimated by each of the individual micro lenses 248a. The collimated output radiation wavelength 250a is then directed to the movable mirror 243a of the array of movable mirrors 243.

After reflection from the movable mirror 243a, an input radiation wavelength 280a is refocused by the individual micro lens 248a to an input focal point 275. If the movable mirror 243a is tilted, as shown, the input focal point 275 is laterally displaced from the output focal point 270. A displacement distance will vary according to the angle of tilt of the movable mirror 243a. In an exemplary embodiment, the focal point displacement direction is perpendicular to a dispersion direction of the diffraction grating 210. However, if the movable mirror 243a is not tilted, thus is perpendicular to an angle of entry of the output radiation wavelength 250a, the output and input radiation wavelengths 250a, 280a will have an output focal point 270 and input focal point 275 that are substantially the same.

While the embodiment illustrated in FIG. 2 shows the movable mirror 243a being rotated about an x-axis, it should be understood that the movable mirror 243a (and for that matter any other movable mirror within the optical system 200) may be a dual axis MEMS mirror, and therefore, rotatable about both the x-axis and the y-axis. As such, the input focal point may be laterally displaced from the output focal point in both the y-direction and the x-direction. Because that illustrated in FIG. 2 is only a cross-section, any lateral displacement in the z-direction may not be observed.

The input radiation wavelength 280a, whether displaced or not, then proceeds through the optical collimator 220 and diffraction grating 210, wherein it is recombined with any other input radiation wavelengths in the form of an input radiation spectrum 280. The input radiation spectrum 280 is then directed back to the optical fiber 260. If at least one of the input focal points 275 is laterally displaced from at least one of the output focal point 270, attenuation may occur to those specific channels where a displacement occurred. More precisely, the lateral displacement between the output focal points 270 and the input focal points 275, may be translated into a similar displacement as those certain wavelengths re-enter the optical fiber 260. See, for example, the lateral shift between the output radiation spectrum 250 and the input radiation spectrum 280 in FIG. 2.

In the current example, the output radiation spectrum 250 and the input radiation spectrum 280 exit and enter, respectively, the optical fiber 260 at a substantially similar angle. As a result, much higher degrees of attenuation may be obtained, as compared to the prior art devices where the attenuation is attained by varying the degree of entry of the input radiation spectrum into the optical fiber 260. For example, in an exemplary embodiment, displacements of greater than about 15 μm may be obtained, resulting in an attenuation of up to about 40 db, a value that is typically not obtained by the prior art devices.

The optical system 200 may also be modified to act as an add/drop system. In such an example, any of the individual radiation wavelengths may be dropped from the optical fiber 260 by deflecting the input focal point 275 of each of the individual radiation wavelengths by a distance that causes that portion of the input radiation spectrum 280 to miss the core of the optical fiber 260. The resulting attenuation may exceed about 40 db and the channel is essentially extinguished from the optical fiber 260.

Additionally, a channel can be added, by introducing a second optical fiber 290, and deflecting one of the individual radiation wavelengths by a distance such that it is incident on the second optical fiber 290. This requires a large angular deflection, but is within the practically achievable range of the movable mirror 243a.

Turning to FIG. 3, illustrated is a plan view of an optical communications system 300, which may form one environment in which an optical system 305 in accordance with the principles of the present invention may be used. An initial signal 310 enters a transmitter 320 of the optical communications system 300. The transmitter 320, receives the initial signal 310, addresses the signal 310 and sends the resulting information across an optical fiber 330 to a receiver 340. The receiver 340 receives the information from the optical fiber 330, addresses the information and sends an output signal 350. As illustrated in FIG. 3, the optical system 305 may be included within the receiver 340. However, the optical system 305 may also be included anywhere in the optical communications system 300, including the transmitter 320. The optical communications system 300 is not limited to the devices previously mentioned. For example, the optical communications system 300 may include another element 360, such as a laser, diode, modulator, optical amplifier, optical waveguide, photodetectors, or other similar device.

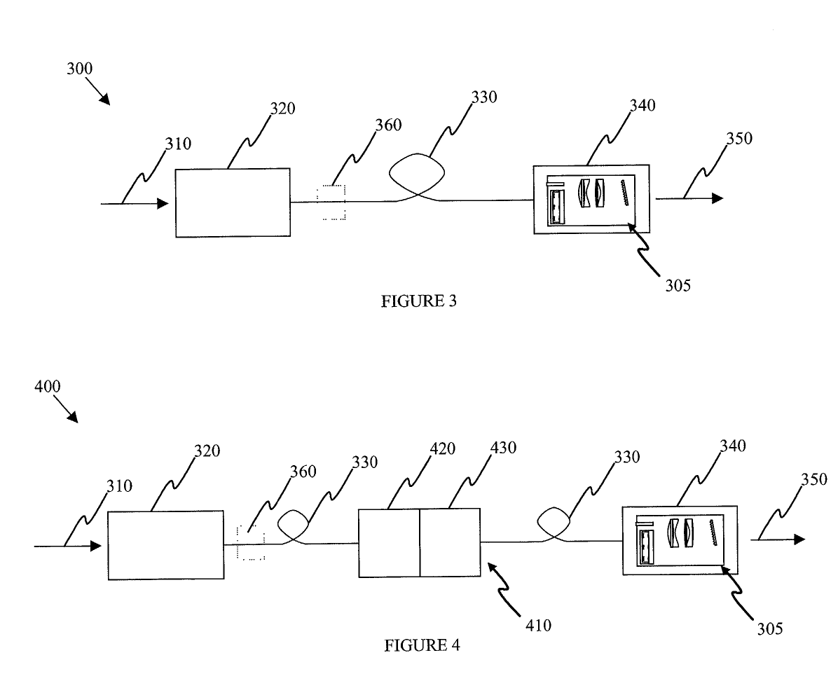

Turning briefly to FIG. 4, illustrated is an alternative optical communications system 400, having a repeater 410, including a second transmitter 420 and a second receiver 430, located between the transmitter 320 and the receiver 340, as well as the optical system 305.

Although the present invention has been described in detail, those skilled in the art should understand that they can make various changes, substitutions and alterations herein without departing from the spirit and scope of the invention in its broadest form.

What is claimed is:

1. An optical device, comprising:
an array of movable mirrors; and
a transparent substrate located adjacent the array of movable mirrors and having an array of micro lenses located thereon, wherein the transparent substrate is aligned with the array of movable mirrors such that each micro lens is aligned with a corresponding mirror of the array of movable mirrors.

2. The optical device as recited in claim 1 further comprising a housing having an opening therein, the housing configured to receive the array of movable mirrors, and wherein the transparent substrate is a cap configured to cover the opening.

3. The optical device as recited in claim 2 wherein the cap provides a hermetic seal for the array of movable mirrors.

4. The optical device as recited in claim 1 wherein each of the micro lenses has a focal length of between about 50 μm and about 500 μm.

5. The optical device as recited in claim 1 wherein the array of movable mirrors and the array of micro lenses are separated by a distance of between about 100 μm and about 1000 μm.

6. The optical device as recited in claim 1 wherein the array of micro lenses are located between the array of movable mirrors and the transparent substrate.

7. The optical device as recited in claim 1 wherein the array of micro lenses are an array of cylinders or an array of spherical, aspherical, diffractive, or cylindrical micro lenses.

8. The optical device as recited in claim 1 wherein the optical device is an optical attenuation device.

9. The optical device as recited in claim 1 wherein the optical device is an optical add/drop device.

10. A method of manufacturing an optical device, comprising:
forming an array of movable mirrors; and
creating a transparent substrate adjacent the array of movable mirrors and having an array of micro lenses located thereon, wherein the transparent substrate is aligned with the array of movable mirrors such that each micro lens is aligned with a corresponding mirror of the array of movable mirrors.

11. The method as recited in claim 10 further including providing a housing having an opening therein, placing the array of movable mirrors within the housing, and capping the opening with the transparent substrate.

12. The method as recited in claim 11 wherein capping the opening with the transparent substrate includes forming a hermetic enclosure for the array of movable mirrors.

13. The method as recited in claim 10 wherein each of the micro lenses has a focal length of between about 50 μm and about 500 μm.

14. The method as recited in claim 10 wherein the array of movable mirrors and the array of micro lenses are separated by a distance of between about 100 μm and about 1000 μm.

15. The method as recited in claim 10 wherein creating a transparent substrate having an array of micro lenses includes creating a transparent substrate having an array of micro lenses located between the array of movable mirrors and the transparent substrate.

16. An optical system, comprising:
a diffraction grating configured to separate a radiation spectrum into different wavelengths:
an optical collimator located between a radiation port and the diffraction grating;
an array of movable mirrors; and
an array of micro lenses located between the optical collimator and the array of movable mirrors, wherein each of the micro lenses are aligned with a corresponding mirror of the array of movable mirrors.

17. The optical system as recited in claim 16 wherein the array of movable mirrors and the array of micro lenses are separated by a distance of between about 100 μm and about 1000 μm.

18. The optical system as recited in claim 16 wherein the diffraction grating comprises a ref lective diffraction grating and the optical collimator comprises an achromatized collimator.

19. The optical system as recited in claim 16 wherein the optical collimator is oriented at 90° to the array of movable mirrors.

20. The optical system as recited in claim 16 further including devices selected from the group consisting of:
lasers,
photodetectors,
optical amplifiers,
transmitters, and
receivers.
